(19) United States
(12) Patent Application Publication
(10) Pub. No.: US 2005/0155249 A1
(43) Pub. Date: Jul. 21, 2005

(54) Apparatus for drying a particulate product with superheated vapour

(76) Inventor: Borge Holm Christensen, Alsgarde (DK)

Correspondence Address: BIRCH STEWART KOLASCH & BIRCH, PO BOX 747, FALLS CHURCH, VA, 22040-0747, US

(21) Appl. No.: 10/499,088

(22) PCT Filed: Dec. 7, 2002
(86) PCT No.: PCT/DK02/00825

(30) Foreign Application Priority Data
Dec. 17, 2001 (DK) PA 2001 01887

(51) Int. Cl. F26B 3/00; F26B 5/14

(52) U.S. Cl. 34/498; 34/398

(57) ABSTRACT

Apparatus for evaporation of a liquid contained in a particulate product by means of superheated vapour as the drying medium, comprising a drying chamber and a heat exchanger and a device for separation of product particles and low temperature vapour, pressuretight connected to each other and communicating with the surroundings through a loading device for particulate product, an unloading device for particulate product and an outlet device for the generated surplus of low temperature vapour characterized in—that the drying chamber by and large has the shape of a cylinder, and—that the drying chamber has a horizontal position or has a minor deviation from that, and—that a rotor inside the drying chamber is elevating portions of the particulate product from the lower to the upper part of the drying chamber from where the portions fall down to the lower part of the drying chamber, through the current of superheated vapour.

Apparatus for evaporation of a liquid contained in a particulate product by means of superheated vapour as the drying medium, comprising a drying chamber and a heat exchanger and a device for separation of product particles and low temperature vapour, pressuretight connected to each other and communicating with the surroundings through a loading device for particulate product, an unloading device for particulate product and an outlet device for the generated surplus of low temperature vapour characterized in
that the drying chamber by and large has the shape of a cylinder, and
that the drying chamber has a horizontal position or has a minor deviation from that, and
that a rotor inside the drying chamber is elevating portions of the particulate product from the lower to the upper part of the drying chamber from where the portions fall down to the lower part of the drying chamber, through the current of superheated vapour.

The most common liquid will be water, and the superheated vapour will then be superheated steam mixed with small amounts of volatile components from the particulate product.

In some cases the liquid will not be water, but for example an organic inflammable solvent. In such cases the apparatus according to the invention can be used to evaporate the major part of the same liquid by means of superheated vapour of the same liquid and thereafter to evaporate the remaining part of the liquid by means of superheated steam.

In other cases the liquid can be mixtures of water and other liquids, such as ethanol.

### BACKGROUND

Drying with superheated vapour is a well established technology with examples of industrial applications within drying of sugar beet pulp and cellulose pulp.

The advantages by drying in superheated vapour are mainly:
1. Very high energy efficiency in cases where the energy in the vapour generated by the drying process can be exploited by condensation in energy consuming processes such as evaporation or distillation.
2. Very low air pollution compared with drying with air as the drying medium.
3. High product quality and no product loss in cases where oxidation of the particulate product is a problem.
4. High safety when the liquid to be removed from the particulate product is inflammable.
5. Simultanous sterilisation and drying is possible.

Prior Art

Existing apparatus for drying with superheated vapour conduct the following unit operations:
1. Loading the particulate product into the drying chamber.
2. Transport of superheated vapour through the drying chamber.
3. Transport of the particulate product through the drying chamber with efficient contact to the superheated vapour.
4. Separation of product particles and low temperature vapour.
5. Unloading of the particulate product from the drying chamber.
6. Reheating and recycling of low temperature vapour.
7. Discharge of the generated surplus of low temperature vapour.

The existing apparatus for drying with superheated vapour differ in the way the above mentioned unit operations are conducted.

The most important differences are:
1. The pressure of the dryer can be higher or lower than the ambient pressure or it can be equal to the ambient pressure. Dryers with higher or lower pressure than the ambient pressure demand pressure locks in connection with loading and unloading of the particulate product.
2. The pressure locks can be based on different principles.
3. The contact between the product particles and the superheated vapour, and the transport of the particulate product through the drying chamber can be arranged in different ways.
4. The drying chamber and the heat exchanger can be separate units or they can be integrated to one unit.
5. The inlet of the superheated vapour into the drying chamber can be at the same end as the inlet of the particulate product (co-current drying) or it can be at the opposite end (counter-current drying).

EP 0 058 651 B1 disclose a dryer wherein the the contact between the product particles and the superheated vapour is accomplished by suspending the particulate product in the superheated vapour and pneumatically transport the particulate product through the pressurized dryer comprising a number of vertical tube and shell heat exchangers connected by pipes. This means, that the drying of the particulate product and the reheating of the vapour are completely integrated and simultanous. The quantity of particulate product per m³ of the drying chamber is very low, and therefore this type of dryer are only suitable for products with small particles wich can be dried within a retention time shorter than 1 minute.

In U.S. Pat. No. 5,357,686 the contact between the product particles and the superheated vapour is accomplished in a vertical ringshaped sectionized fluid bed drying chamber. Reheating of the low tempeature vapour is accomplished by a tube and shell heat exchanger placed in the center of the drying chamber. The superheated vapour enters through the perforated bottom of the drying chamber. Separation of the product particles from the low temperature vapour occurs at the top of the drying chamber and after removal of fines in a cyclone, a part of the low temperature vapour is recycled through the heat exchanger, while the remaining part is discharged to external utilization.

By adjusting the flow of superheated vapour in the vertical sections of the drying chamber the retention time for the particulate product in each section can be cotrolled and to some degree provide a shorter retention time for smaller particles than for the larger particles.

PCT/DK99/00196 disclose a similar design of the dryer, but the low temperature vapour entrance of the cyclone has been moved upwards, and the ringshaped fluidized bed has got a curved bottom plate. This is claimed to improve drying of coarse particles without overdrying medium and smaller particles, and providing a better investment: capacity ratio than the apparatus disclosed in U.S. Pat. No. 5,357,686.

The quantity of particulate product per m³ of the drying chamber is low, and therefore this type of dryer has its best performance by products with particles which can be dried within a retention time shorter than 10 minutes.

All three dryers described above are operating at a pressure of 2-6 bar to achieve increased evaporation capacity per m³ of drying chamber.

Rotary dryers working with hot air as drying medium have been used for more than a century for drying of a wide range of particulate products. Rotary dryers working with superheated vapour as drying medium have been used in a few cases during the last decade, and are commercial available from companies such as W. Kunz Drytec A G, CH-5606 Dinticon, or Atlas Industries A/S Baltorpvej 160, DK-2750 Ballerup.

By these dryers the drying chamber (the rotary shell) is connected to the heat exchanger and the separation device by seals which are not pressuretight. The contact between the product particles and the superheated vapour in the rotary shell is achieved by a serie of falls of the particulate product from the upper part of the rotary shell through the current of superheated vapour moving from the inlet end to the outlet end of the rotary shell. During a fall, the product particles are moved a step towards the outlet, the length of which depends of the velocity of the superheated vapour and the weight and form of the individual particles. Between the falls, the product particles are either resting at the lower part of the shell or being elevated to the upper part of the rotary shell by baffles placed horisontally on the inner side of the rotary shell, from where it will again fall through the superheated vapour.

The dryers from W. Kunz Drytec A G and Atlas Industries A/S are co-current dryers, but an example of a counter-current dryer is described in “Unit Operations of Chemical Engineering” McGraw-Hill, International Editions 1987 p. 732-733. This dryer is working with heated air as drying medium, but could in principle be working with superheated vapour. During counter-current drying, the drying medium will give a negative contribution to the transport of particulate product through the drying chamber. To compensate for this, the rotary shell is sloping so the outlet end for the particulate product is lower than the inlet end.

During a fall of a particle the transfer rate for energy from the superheated vapour to the particle is very high, reducing the content of liquid in the surface layer to a lower level than inside the particle. When the particulate product is located at the lower part of the drying chamber, the transfer rate for energy from the superheated vapour to the particulate product is low, which gives time for the liquid to move from the inner part of the particle to the surface.

This drying principle characterized by alternating periods with high and low drying rate, is in the following called pulsatory drying.

Pulsatory drying provides uniform drying of heterogenous particulate product, where the needed retention time for the smallest particles may be few seconds, whereas it may be 30 minutes or more for the largest particles. The very long retention time for large paticles is possible because a great quantity of particulate product can be accumulated at the lower part of the rotary shell. Furthermore the pulsatory drying will allow for higher inlet temperatures without thermal detonation of the product.

None of the existing rotary dryers working with superheated vapour as a drying medium can operate at pressures different from the atmospheric pressure, because efficient seals between the rotary shell and the stationary equipment connected to it have not been available. Therefore these dryers operate at the atmospheric pressure or a little lower to avoid emissions. This means, that the vapour generated by the drying process has a low temperature and is diluted with air, which reduces the application value of the vapour substantially.

The aim of the apparatus according to the invention is to integrate pulsatory drying and drying with superheated vapour in a complete pressuretight drying system. Thereby all the well known advantages by drying with superheated vapour can be exploited to full extent and be combined with the advantages by pulsatory drying.

Surprisingly it has been possible to establish pulsatory drying with superheated vapour in a complete pressuretight drying system without innovating new efficient seals between the rotary shell and the stationary equipment. The apparatus according to the invention do not apply seals in this connection at all. Instead the drying chamber by and large has the shape of a horizontal cylinder inside wich is placed a rotor. The rotor elevates the particulate product from the lower part of the drying chamber to the upper part from where it falls down through the current of superheated vapour as required to conduct pulsatory drying.

The rotor and the drying chamber can be designed in different ways depending on the nature of the particulate product. When the liquid can move quickly from the core of the particles to the surface, and the demand for resting time therefore is low, a preferred embodiment of the rotor comprises an axis placed parallel to the axis of the drying chamber, equipped with a number of radial beams carrying baffles at the end away from the axis. The axis of the rotor is placed in such a manner, that the baffles will pass close to the shell and collect some particulate product when they pass through the lower part of the drying chamber, and will pass with some distance to the shell, when they move through the upper part of the drying chamber, which will allow the product particles to slip out into the space between the baffles and the shell from where it will fall down through the superheated vapour. This will occur when the rotation speed is increased to a level where the impact on the particulate product of the centrifugal force is stronger than the gravity force. When the gravity force is the strongest the product particles will fall directly from the baffles.

When the liquid moves slowly form the core of the particle to the surface and the demand for resting time at the lower part of the drying chamber therefore is high, a preferred embodiment of the invention comprices a cylindric drying chamber inside which a cylindric rotary shell is placed conaxially with the drying chamber. The rotary shell can rotate freely inside the stationary drying chamber but the space between the two cylinders is very narrow. Support and rotation of the rotary shell are achieved by well known devices.

Loading and unloading of the drying apparatus according to the invention can be conducted by well known devices such as rotary locks or plug flow feeders. However for some particulate products none of the known devices are suitable. Examples are cereal straw, household waste, brown coal, wood chips, bark and byproducts from slaughter houses.

In such cases the apparatus according the invention can be equipped with loading and unloading system described in patent application P.A. 2000 01183 filed 08.08.2000.

The loading/unloading system described in P.A. 2000 01183 is based on a sluice system according to which the product is first conveyed through a portioning device, which produces a sequence of uniform product portions divided by uniform particle free spaces, and subsequently the product portions are conveyed individually through a sluice device, which comprises at least one sluice chamber and two pressure locks of which at least one at any time secures a pressure tight barrier between the two pressure zones, and wherein the product portions are force loaded from the first zone into a sluice chamber by means of a piston screw, the axis of which is practically in line with the axis of the sluice chamber, and wherein the product portions are force unloaded from the sluice chamber and into the second pressure zone by means of said piston screw or a piston or by means of gas, vapour or liquid supplied at a pressure higher than that of the second pressure zone.

In cases where the particulate product is subjected to mechanical dewatering before drying in the apparatus according to the invention, a preferred embodiment uses a screw press, pressuretight connected to the drying chamber, both as dewatering device and as loading device.

In cases where the particulate product after drying in the apparatus according to the invention has to be pelletized a preferred embodiment of the invention uses a pellet press, pressuretight connected to the drying chamber, both for unloading and for pelletizing.

### DETAILED DESCRIPTION

In the following the invention is described in details by means of two co-current embodiments with different rotor types.

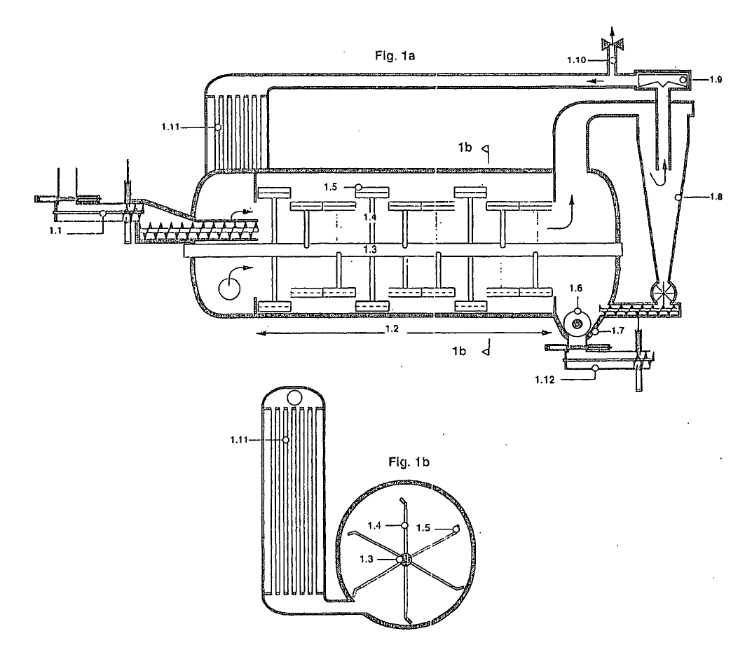

Example 1 describes an embodiment preferred when the liquid can move quickly from the core of the particles to the surface, and the demand for resting time therefore is low. FIGS. 1a and 1b are illustrating example 1. FIG. 1a is a longitude section of the apparatus, FIG. 1b is a cross section of the drying chamber.

The particulate product is loaded into the drying chamber 1.2 by means of a loading device 1.1, Patent application P.A. 2000 01183. In the drying chamber 1.2 the particulate product is elevated by means of the rotor baffles 1.5 connected with beams 1.4 to the rotor axis 1.3. At the outlet end of the drying chamber, the particulate product falls into a hopper 1.7 with a screw conveyor 1.6, wich conveys the particulate product to the unloading device 1.12, similar to 1.1.

The superheated vapour pass through a cyclone 1.8 where it is separated from the fines which are led to the hopper 1.7. The movement of the superheated vapour is achieved by means of the fan 1.9.

The surplus of vapour is discharged through the outlet valve 1.10, and the rest of the vapour is reheated in the heat exchanger 1.11 and conducted into the drying chamber 1.2. The supply of primary energy to the heat exchanger is not shown.

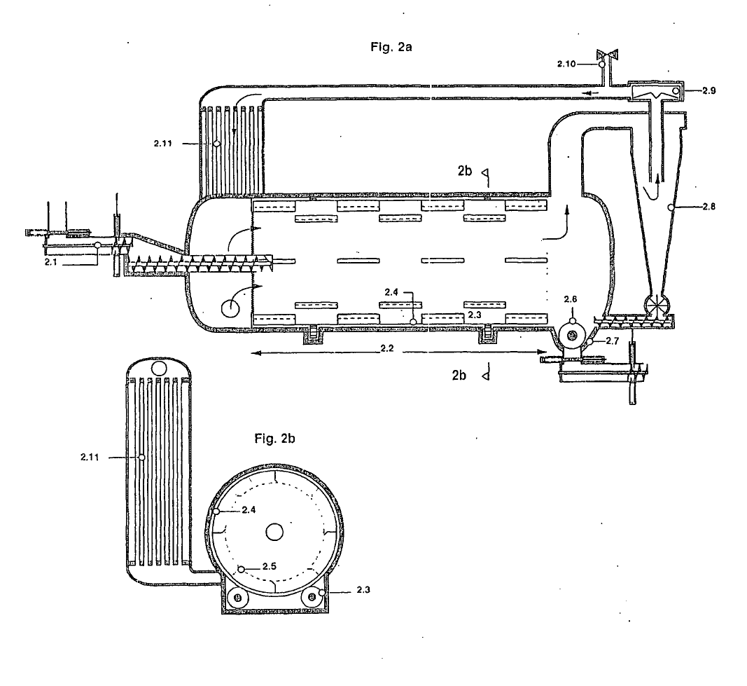

Example 2 describes an embodiment preferred when the liquid moves slowly form the core of the particles to the surface and the demand for resting time at the lower part of the drying chamber therefore is high. FIGS. 2a and 2b are illustrating example 2. FIG. 2a is a longitude section of the apparatus, FIG. 2b is a cross section of the drying chamber.

The particulate product is loaded into the drying chamber 2.2 by means of a loading device 2.1, similar to 1.1. The rotor 2.4 in the drying chamber 2.2 consist of a rotary shell in which the particulate product is elevated by means of the rotor baffles 2.5 connected to the inside of the rotary shell 2.4. Rotation of the rotary shell is achieved by known means. At the outlet end of the drying chamber, the particulate product falls into a hopper 2.7 with a screw conveyor 2.6, wich conveys the particulate product to the unloading device 2.12.

The superheated vapour pass through a cyclone 2.8 where it is separated from the fines which are led to the hopper 2.7. The movement of the superheated vapour is achieved by means of the fan 2.9.

The surplus of vapour is discharged through the outlet valve 2.10, and the rest of the vapour is reheated in the heat exchanger 2.11 and conducted into the drying chamber 2.2. The supply of primary energy to the heat exchanger is not shown.

1. Apparatus for evaporation of a liquid contained in a particulate product by means of superheated vapour as the drying medium, comprising a drying chamber and a heat exchanger and a device for separation of product particles and low temperature vapour, pressuretight connected to each other and communicating with the surroundings through a loading device for particulate product, an unloading device for particulate product and an outlet device for the generated surplus of low temperature vapour characterized in
that the drying chamber by and large has the shape of a cylinder and
that the drying chamber can be in a horizontal position or have a minor deviation from that, and
that a rotor inside the drying chamber is arranged to, during operation of the apparatus, elevate portions of the particulate product from the lower to the upper part of the drying chamber from where the portions fall down to the lower part of the drying chamber, through the current of superheated vapour.

2. Apparatus according to claim 1, wherein the rotor comprises a central axis with radial beams and elevating baffles connected to the beams.

3. Apparatus according to claim 1, wherein the rotor comprises a rotary shell with elevating baffles connected to the inner cylindric wall of the shell.

4. Apparatus according to claim 1, wherein the loading is carried out by a screw press, pressuretight connected to the drying chamber and wherein the screw press Is providing mechanical dewatering of the particulate product before the drying process,

5. Apparatus according to claim 1, wherein the loading is carried out by a particle pump.

6. Apparatus according to claim 1, wherein the unloading is carried out by a pellet press, pressuretight connected to the drying chamber, and wherein the pelletpress is providing pelletizing of the particulate product after the drying process.

7. Apparatus according to claim 1 wherein the unloading is carried out by a particle pump.
